(19) United States
(12) Patent Application Publication
(10) Pub. No.: US 2002/0119295 A1
(43) Pub. Date: Aug. 29, 2002

(54) Radiation triggerable oxygen scavenging article with a radiation curable coating

(76) Inventors: Drew V. Speer, Simpsonville, SC (US); Thomas D. Kennedy, Simpsonville, SC (US)

Correspondence Address: Cryovac, Inc., P.O. Box 464, Duncan, SC, 29334, US

(21) Appl. No.: 09/860,388

(22) Filed: May 18, 2001

Related U.S. Application Data
(60) Provisional application No. 60/258,110, filed on Dec. 22, 2000.

(51) Int. Cl. B32B 3/00; B32B 27/14

(52) U.S. Cl. 428/195; 428/206

(57) ABSTRACT

An article includes a first and second outer surface, and a first layer including an oxygen scavenger, the first outer surface including a printed image, and a radiation-curable varnish covering at least a portion of the image. A method includes providing an article including a first and second outer surface, and a first layer including an oxygen scavenger; printing an image on the first outer surface; and applying a radiation-curable varnish on the first outer surface so as to cover at least a portion of the image. A multilayer article includes a first and second outer surface; and a first layer including an oxygen scavenger; wherein the first outer surface includes a radiation-curable printed image. A method includes providing an article including a first and second outer surface, and a first layer including an oxygen scavenger; and printing a radiation-curable image on the first outer surface.

This application claims the benefit of U.S. Provisional Application No. 60/258,110, filed Dec. 22, 2001.

### FIELD OF THE INVENTION

The invention relates to a radiation triggerable oxygen scavenging article with a radiation curable coating, and a process for making same.

### BACKGROUND OF THE INVENTION

Some current packaging systems involving oxygen scavenging technology, as disclosed further below, rely upon the article, such as a film, being triggerable by actinic radiation. Such actinic radiation is typically in the form of ultra-violet (UV) light or an electron beam (e-beam).

Many packaging films are printed. In many commercial applications, it is desirable to utilize UV or e-beam cured inks and over-print varnishes (OPV), as disclosed further below, because of their superior physical properties such as high gloss and high abuse resistance. UV or e-beam cured inks and OPV are also attractive in terms of their environmental benefits, because they typically exhibit low or no volatile organic compound (VOC) emissions.

The inventors have found that it would be desirable to utilize oxygen scavenging technology, as described herein, in making articles such as packaging films, and also to print these same articles utilizing UV or e-beam cured inks and/or over-print varnishes. However, it would seem that such energy cured inks and varnishes would be fundamentally incompatible with an oxygen scavenging article designed to be triggered at a later point in time by just such radiation. That is, the process of curing the ink and/or OPV would be assumed to undesirably, prematurely trigger the scavenging reaction. This would be especially true for the more energetic e-beam radiation.

The inventors have nevertheless now discovered, that if the article structure is carefully designed, and the energy source is properly chosen, these two apparently mutually exclusive technologies can be combined into the same article.

This is accomplished in several ways. In the case of UV, a layer is included in the article that comprises a UV absorber. Such a material will absorb UV and/or be opaque to UV, so that an ink or OPV can be cured on one side or major surface of the article while the oxygen scavenging layer on the other side is protected from premature triggering. The article can then, at the desired time, for example at the product packaging line, be triggered by irradiation from the opposite side or major surface of the article, which would be chosen to be suitably UV transparent. Suitable UV absorbers are for example, polymeric UV absorbers such as polyethylene terephthalate (PET), saran (polyvinylidene dichloride or PVDC), saran coated PET, polystyrene, styrene copolymer such as styrene/butadiene copolymer, styrene/methyl acrylate copolymer, and ethylene/styrene copolymer, aromatic polyamide, and polycarbonate. Such materials will readily block short wave length UV light (UV-C) and to some extent longer wavelength UV. When longer wavelength UV light (UV-B and UV-A) also needs to be blocked, polymers such as polyethylene naphthalate (PEN) can be used. Blends of any of these materials can also be used.

Additives can be used, in addition to or in lieu of the UV absorbers disclosed above, to absorb and/or block UVC, UV-A and UV-B. These are well known in the art as sunscreens. Examples are substituted 2-hydroxybenzophenones, substituted benzotriazoles and substituted cinnamates, and pigments such as titanium dioxide, iron oxide, carbon black, and aluminum oxide, and the like. Thus, by utilizing UV absorbing and/or opaque materials, energy curable ink and OPV systems can be cured by UV, while retaining the ability to trigger the article by the same type of radiation later in time, for example at a food processor location.

The UV absorber or additive which absorbs and/or blocks UV radiation can be disposed at any suitable location in the structure of the article, such as a film or wall layer or layers or a portion or component thereof, a film or wall surface or a portion or component thereof, the print or varnish (if not radiation-curable) or a portion or component thereof, etc. as long as the UV absorber or additive is effective for the intended purpose of allowing for the curing of a printed image and/or an overprint varnish, without prematurely triggering an oxygen scavenger present in the article.

Thus, it is sometimes sufficient to attenuate or provide partial absorbance or blocking; depending on the type of absorber, the type of scavenger, the type and thickness of the article, dosage and energy of radiation. Sometimes small amounts of the UV absorber will totally absorb the UV, e.g. about 5%, by weight of the layer in which the absorber is present, of aromatic nylon will normally totally absorb the UV radiation.

Alternatively, or in combination with the above UV absorbers or additives, asymmetrical film construction can be used to allow for the use of energy curable ink and OPV systems with radiation triggerable oxygen scavenging film. This is disclosed in more detail herein.

Definitions

“Film” herein means a film, laminate, sheet, web, coating, or the like which can be used to package a product.

“Oxygen scavenger” (OS) and the like herein means a composition, article or the like which consumes, depletes or reacts with oxygen from a given environment.

“Actinic radiation” and the like herein means electromagnetic radiation, e.g. in the form of UV, X-ray, gamma ray, corona discharge, or electron beam irradiation, capable of causing a chemical change, as exemplified in U.S. Pat. No. 5,211,875 (Speer et al.).

“Functional barrier” herein means a polymeric material, which acts as a selective barrier to by-products from the oxygen scavenging reaction but not to oxygen.

“LLDPE” herein means linear low density polyethylene, which is an ethylene/alpha-olefin copolymer.

“EVA” herein means ethylene/vinyl acetate copolymer.

“Polymer” and the like herein means a homopolymer, but also copolymers thereof, including bispolymers, terpolymers, etc.

“Ethylene/alpha-olefin copolymer” and the like herein means such heterogeneous materials as linear low density polyethylene (LLDPE), linear medium density polyethylene (LMDPE) and very low and ultra low density polyethylene (VLDPE and ULDPE); and homogeneous polymers such as metallocene catalyzed polymers such as EXACT (TM) materials supplied by Exxon, and TAFMER (TM) materials supplied by Mitsui Petrochemical Corporation. These materials generally include copolymers of ethylene with one or more comonomers selected from C₄ to C₁₀ alpha-olefins such as butene-1 (i.e., 1-butene), hexene-1, octene-1, etc. in which the molecules of the copolymers comprise long chains with relatively few side chain branches or cross-linked structures. This molecular structure is to be contrasted with conventional low or medium density polyethylenes, which are more highly branched than their respective counterparts. Other ethylene/a-olefin copolymers, such as the long chain branched homogeneous ethylene/a-olefin copolymers available from the Dow Chemical Company, known as AFFINITY (TM) resins, are also included as another type of ethylene alpha-olefin copolymer useful in the present invention. It is further contemplated that single-site catalyzed polyethylenes, known as Versipol™ (DuPont), will be useful in the present invention.

As used herein, the term “polyamide” refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, also referred to generally as “copolyamides” herein.

“Trigger” and the like refers herein to that process defined in U.S. Pat. No. 5,211,875, whereby oxygen scavenging is initiated (i.e. activated) by exposing an article such as a film to actinic radiation, such as ionizing radiation, such as ultraviolet radiation, having a wavelength of less than about 750 nm at an intensity of at least about 1.6 mW/cm² or an electron beam at a dose of at least 0.2 megarads (MR), wherein after initiation the oxygen scavenging rate of the article is at least about 0.05 cc oxygen per day per gram of oxidizable organic compound for at least two days after oxygen scavenging is initiated. Preferred is a method offering a short “induction period” (the time that elapses, after exposing the oxygen scavenging component to a source of actinic radiation, before initiation of the oxygen scavenging activity begins) so that the oxygen scavenging component can be activated at or immediately prior to use during filling and sealing of a container, made wholly or partly from the article, with an oxygen sensitive material.

Thus, “trigger” refers to exposing an article to actinic radiation as described above; “initiation” refers to the point in time at which oxygen scavenging actually begins or is activated; and “induction time” refers to the length of time, if any, between triggering and initiation.

### SUMMARY OF THE INVENTION

In one aspect of the invention, a multilayer article comprises a first outer surface; a second outer surface; and a first layer comprising an oxygen scavenger; wherein the first outer surface comprises a printed image, and a radiation-curable varnish covering at least a portion of the printed image.

In a second aspect of the invention, a method comprises providing a multilayer article comprising a first outer surface, a second outer surface, and a first layer comprising an oxygen scavenger; printing an image on the first outer surface; and applying a radiation-curable varnish on the first outer surface so as to cover at least a portion of the printed image.

In a third aspect of the invention, a multilayer article comprises a first outer surface; a second outer surface; and a first layer comprising an oxygen scavenger; wherein the first outer surface comprises a radiation-curable printed image.

In a fourth aspect of the invention, a method comprises providing a multilayer article comprising a first outer surface, a second outer surface, and a first layer comprising an oxygen scavenger; and printing a radiation-curable image on the first outer surface.

### DETAILED DESCRIPTION OF THE INVENTION

The Oxygen Scavenger

Oxygen scavengers suitable for commercial use in articles of the present invention, such as films, are disclosed in U.S. Pat. No. 5,350,622, and a method of initiating oxygen scavenging generally is disclosed in U.S. Pat. No 5,211,875. Both applications are incorporated herein by reference in their entirety. According to U.S. Pat. No. 5,350,622, oxygen scavengers are made of an ethylenically unsaturated hydrocarbon and transition metal catalyst. The preferred ethylenically unsaturated hydrocarbon may be either substituted or unsubstituted. As defined herein, an unsubstituted ethylenically unsaturated hydrocarbon is any compound that possesses at least one aliphatic carbon-carbon double bond and comprises 100% by weight carbon and hydrogen. A substituted ethylenically unsaturated hydrocarbon is defined herein as an ethylenically unsaturated hydrocarbon which possesses at least one aliphatic carbon-carbon double bond and comprises about 50% -99% by weight carbon and hydrogen. Preferable substituted or unsubstituted ethylenically unsaturated hydrocarbons are those having two or more ethylenically unsaturated groups per molecule. More preferably, it is a polymeric compound having three or more ethylenically unsaturated groups and a molecular weight equal to or greater than 1,000 weight average molecular weight.

Examples of unsubstituted ethylenically unsaturated hydrocarbons include, but are not limited to, diene polymers such as polyisoprene, (e.g., trans-polyisoprene) and copolymers thereof, cis and trans 1,4-polybutadiene, 1,2-polybutadienes, (which are defined as those polybutadienes possessing greater than or equal to 50% 1,2 microstructure), and copolymers thereof, such as styrene-butadiene copolymer. Such hydrocarbons also include polymeric compounds such as polypentenamer, polyoctenamer, and other polymers prepared by cyclic olefin metathesis; diene oligomers such as squalene; and polymers or copolymers with unsaturation derived from dicyclopentadiene, norbornadiene, 5-ethylidene-2-norbornene, 5-vinyl-2-norbornene, 4-vinylcyclohexene, 1,7-octadiene, or other monomers containing more than one carbon-carbon double bond (conjugated or non-conjugated).

Examples of substituted ethylenically unsaturated hydrocarbons include, but are not limited to, those with oxygen-containing moieties, such as esters, carboxylic acids, aldehydes, ethers, ketones, alcohols, peroxides, and/or hydroperoxides. Specific examples of such hydrocarbons include, but are not limited to, condensation polymers such as polyesters derived from monomers containing carbon-carbon double bonds, and unsaturated fatty acids such as oleic, ricinoleic, dehydrated ricinoleic, and linoleic acids and derivatives thereof, e.g. esters. Such hydrocarbons also include polymers or copolymers derived from (meth)allyl (meth)acrylates. Suitable oxygen scavenging polymers can be made by trans-esterification. Such polymers are disclosed in U.S. Pat. No. 5,859,145 (Ching et al.) (Chevron Research and Technology Company), incorporated herein by reference as if set forth in full. The composition used may also comprise a mixture of two or more of the substituted or unsubstituted ethylenically unsaturated hydrocarbons described above. While a weight average molecular weight of 1,000 or more is preferred, an ethylenically unsaturated hydrocarbon having a lower molecular weight is usable, especially if it is blended with a film-forming polymer or blend of polymers.

Ethylenically unsaturated hydrocarbons which are appropriate for forming solid transparent layers at room temperature are preferred for scavenging oxygen in the packaging articles described above. For most applications where transparency is necessary, a layer which allows at least 50% transmission of visible light is preferred.

When making transparent oxygen-scavenging layers according to this invention, 1,2-polybutadiene is useful at room temperature. For instance, 1,2-polybutadiene can exhibit transparency, mechanical properties and processing characteristics similar to those of polyethylene. In addition, this polymer is found to retain its transparency and mechanical integrity even after most or all of its oxygen uptake capacity has been consumed, and even when little or no diluent resin is present. Even further, 1,2-polybutadiene exhibits a relatively high oxygen uptake capacity and, once it has begun to scavenge, it exhibits a relatively high scavenging rate as well.

When oxygen scavenging at low temperatures is desired, 1 ,4-polybutadiene, and copolymers of styrene with butadiene, and styrene with isoprene are useful. Such compositions are disclosed in U.S. Pat. No. 5,310,497 issued to Speer et al. on May 10, 1994 and incorporated herein by reference as if set forth in full. In many cases it may be desirable to blend the aforementioned polymers with a polymer or copolymer of ethylene.

Other oxygen scavengers which can be used in connection with this invention are disclosed in U.S. Pat. No. 5,958,254 (Rooney), incorporated by reference herein in its entirety. These oxygen scavengers include at least one reducible organic compound which is reduced under predetermined conditions, the reduced form of the compound being oxidizable by molecular oxygen, wherein the reduction and/or subsequent oxidation of the organic compound occurs independent of the presence of a transition metal catalyst. The reducible organic compound is preferably a quinone, a photoreducible dye, or a carbonyl compound which has absorbence in the UV spectrum.

An additional example of oxygen scavengers which can be used in connection with this invention are disclosed in PCT patent publication WO 99/48963 (Chevron Chemical et al.). These oxygen scavengers include a polymer or oligomer having at least one cyclohexene group or functionality. These oxygen scavengers include a polymer having a polymeric backbone, cyclic olefinic pendent group, and linking group linking the olefinic pendent group to the polymeric backbone.

An oxygen scavenging composition suitable for use with the invention comprises:

(a) a polymer or lower molecular weight material containing substituted cyclohexene functionality according to the following diagram:

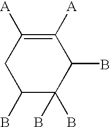

where A may be hydrogen or methyl and either one or two of the B groups is a heteroatom-containing linkage which attaches the cyclohexene ring to the said material, and wherein the remaining B groups are hydrogen or methyl;

(b) a transition metal catalyst; and optionally

(c) a photoinitiator.

The compositions may be polymeric in nature or they may be lower molecular weight materials. In either case, they may be blended with further polymers or other additives. In the case of low molecular weight materials, they will most likely be compounded with a carrier resin before use.

When used in forming a packaging article, the oxygen scavenging composition of the present invention can include only the above-described polymers and a transition metal catalyst. However, photoinitiators can be added to further facilitate and control the initiation of oxygen scavenging properties. Adding a photoinitiator or a blend of photoinitiators to the oxygen scavenging composition can be preferred, especially where antioxidants have been added to prevent premature oxidation of the composition during processing and storage.

Suitable photoinitiators are known to those skilled in the art. See, e.g., U.S. Pat. No. 6,139,770 (Katsumoto et al.), and U.S. patent application No. 857,226 filed May 16, 1997, both of which are incorporated herein by reference as if set forth in full. Specific examples of suitable photoinitiators include, but are not limited to, benzophenone, and its derivatives, such as methoxybenzophenone, dimethoxybenzophenone, dimethylbenzophenone, diphenoxybenzophenone, allyloxybenzophenone, diallyloxybenzophenone, dodecyloxybenzophenone, dibenzosuberone, 4,4′-bis(4-isopropylphenoxy)benzophenone, 4-morpholinobenzophenone, 4-aminobenzophenone, tribenzoyl triphenylbenzene, tritoluoyl triphenylbenzene, 4,4′-bis(dimethylamino)-benzophenone, acetophenone and its derivatives, such as, o-methoxy-acetophenone, 4′-methoxyacetophenone, valerophenone, hexanophenone, α-phenyl-butyrophenone, p-morpholinopropiophenone, benzoin and its derivatives, such as, benzoin methyl ether, benzoin butyl ether, benzoin tetrahydropyranyl ether, 4-o-morpholinodeoxybenzoin, substituted and unsubstituted anthraquinones, α-tetralone, acenaphthenequinone, 9-acetylphenanthrene, 2-acetyl-phenanthrene, 10-thioxanthenone, 3-acetylphenanthrene, 3-acetylindole, 9-fluorenone, 1-indanone, 1,3,5-triacetylbenzene, thioxanthen-9-one, isopropylthioxanthen-9-one, xanthene-9-one, 7-H-benz[de]anthracen-7-one, 1′-acetonaphthone, 2′-acetonaphthone, acetonaphthone, benz[a]anthracene-7,12-dione, 2,2-dimethoxy-2-phenylacetophenone, α,α-diethoxyacetophenone, α,α-dibutoxyacetophenone, 4-benzoyl-4′-methyl(diphenyl sulfide) and the like. Single oxygen-generating photosensitizers such as Rose Bengal, methylene blue, and tetraphenylporphine as well as polymeric initiators such as poly(ethylene carbon monoxide) and oligo[2-hydroxy-2-methyl-1-[4-(1-methylvinyl)phenyl] propanone] also can be used. However, photoinitiators are preferred because they generally provide faster and more efficient initiation. When actinic radiation is used, photoinitiators also can provide initiation at longer wavelengths, which are less costly to generate and present less harmful side effects than shorter wavelengths.

When a photoinitiator is present, it can enhance and/or facilitate the initiation of oxygen scavenging by the composition of the present invention upon exposure to radiation. The amount of photoinitiator can depend on the amount and type of cyclic unsaturation present in the polymer, the wavelength and intensity of radiation used, the nature and amount of antioxidants used, and the type of photoinitiator used. The amount of photoinitiator also can depend on how the scavenging composition is used. For instance, if a photoinitiator-containing composition is in a film layer, which underneath another layer is somewhat opaque to the radiation used, more initiator might be needed. However, the amount of photoinitiator used for most applications ranges from about 0.01 to about 10% (by wt.) of the total composition. Oxygen scavenging can be initiated by exposing an article containing the composition of the present invention to actinic or electron beam radiation, as described below.

Also suitable for use in the present invention is the oxygen scavenger of copending U.S. patent application U.S. Ser. No. 09/350336, filed Jul. 9, 1999, incorporated herein by reference in its entirety, which discloses a copolymer of ethylene and a strained, cyclic alkylene, preferably cyclopentene; and a transition metal catalyst.

Another oxygen scavenger which can be used in connection with this invention is the oxygen scavenger of U.S. Pat. No. 6,214,254 (Gauthier et al.), incorporated herein by reference in its entirety, which discloses ethylene/vinyl aralkyl copolymer and a transition metal catalyst.

As indicated above, the ethylenically unsaturated hydrocarbon is combined with a transition metal catalyst. Suitable metal catalysts are those which can readily interconvert between at least two oxidation states.

Preferably, the catalyst is in the form of a transition metal salt, with the metal selected from the first, second or third transition series of the Periodic Table. Suitable metals include, but are not limited to, manganese II or III, iron II or III, cobalt II or III, nickel II or III, copper I or II, rhodium II, III or IV, and ruthenium II or III. The oxidation state of the metal when introduced is not necessarily that of the active form. The metal is preferably iron, nickel or copper, more preferably manganese and most preferably cobalt. Suitable counterions for the metal include, but are not limited to, chloride, acetate, stearate, palmitate, caprylate, linoleate, tallate, 2-ethylhexanoate, neodecanoate, oleate or naphthenate. Particularly preferable salts include cobalt (II) 2-ethylhexanoate, cobalt stearate, and cobalt (II) neodecanoate. The metal salt may also be an ionomer, in which case a polymeric counterion is employed. Such ionomers are well known in the art.

Any of the above-mentioned oxygen scavengers and transition metal catalyst can be further combined with one or more polymeric diluents, such as thermoplastic polymers which are typically used to form film layers in plastic packaging articles. In the manufacture of certain packaging articles well known thermosets can also be used as the polymeric diluent.

Polymers which can be used as the diluent include, but are not limited to, polyethylene terephthalate (PET), polyethylene, low or very low density polyethylene, ultra-low density polyethylene, linear low density polyethylene, polypropylene, polyvinyl chloride, polystyrene, and ethylene copolymers such as ethylene-vinyl acetate, ethylene-alkyl (meth)acrylates, ethylene-(meth)acrylic acid and ethylene-(meth)acrylic acid ionomers. Blends of different diluents may also be used. However, as indicated above, the selection of the polymeric diluent largely depends on the article to be manufactured and the end use. Such selection factors are well known in the art.

Further additives can also be included in the composition to impart properties desired for the particular article being manufactured. Such additives include, but are not necessarily limited to, fillers, pigments, dyestuffs, antioxidants, stabilizers, processing aids, plasticizers, fire retardants, anti-fog agents, etc.

The mixing of the components listed above is preferably accomplished by melt-blending at a temperature in the range of 50° C. to 300° C. However, alternatives such as the use of a solvent followed by evaporation may also be employed. The blending may immediately precede the formation of the finished article or preform or precede the formation of a feedstock or masterbatch for later use in the production of finished packaging articles.

Oxygen scavenging structures can sometimes generate reaction byproducts, which can affect the taste and smell of the packaged material (i.e. organoleptic properties), or raise food regulatory issues. These by-products can include organic acids, aldehydes, ketones, and the like. This problem can be minimized by the use of polymeric functional barriers. A polymeric functional barrier is a polymeric material, which acts as a selective barrier to by-products from the oxygen scavenging reaction, but is not itself a significant barrier to oxygen. The functional barriers are selected from the group consisting of one or more of the following: polymers comprising a propylene monomer, polymers comprising a methyl acrylate monomer, polymers comprising a methacrylic acid monomer, polyethylene terephthalate glycol (PETG), amorphous nylon, ionomer, and polymeric blends comprising a polyterpene. Such functional barrier polyterpene blends are disclosed in WO 94/06626 to Balloni et al. which is incorporated her by reference as if set forth in full. Examples include but are not limited to polypropylene, propylene/ethylene copolymers, ethylene/methacrylic acid copolymer, and ethylene/methyl acrylate copolymer. The functional barrier polymer(s) may further be blended with another polymer to modify the oxygen permeability as required by some applications. The functional barriers can be incorporated into one or more layers of a multilayer film or container that includes an oxygen scavenging layer. However, one of ordinary skill in the art will readily recognize that the present invention is applicable to any oxygen scavenging system that produces by-products such as organic acids, aldehydes, ketones, and the like.

Polymeric functional barriers for oxygen scavenging applications are disclosed in WO 96/08371 to Ching et al.(Chevron Chemical Company), and copending U.S. patent application Ser. Nos. 08/813752 (Blinka et al.) and 09/445645 (Miranda), all of which are incorporated herein by reference as if set forth in full. The materials in these publications and applications collectively include high glass transition temperature (T_{g}) glassy polymers such as polyethylene terephthalate (PET) and nylon 6 that are preferably further oriented; low T_{g} polymers and their blends; a polymer derived from a propylene monomer; a polymer derived from a methyl acrylate monomer; a polymer derived from a butyl acrylate monomer; a polymer derived from a methacrylic acid monomer; polyethylene terephthalate glycol (PETG); amorphous nylon; ionomer; a polymeric blend including a polyterpene; and poly (lactic acid).

In certain applications of oxygen scavenging, it is desirable to provide polymeric materials with low oxygen transmission rates, i.e. with high barrier to oxygen. In these cases, it is preferred that the oxygen permeability of the barrier be less than 500 cm³O₂/m²·day·atmosphere (tested at 1 mil thick and at 25° C. according to ASTM D3985), preferably less than 100, more preferably less than 50 and most preferably less than 25 cm³O₂/m²·day·atmosphere such as less than 10, less than 5, and less than 1 cm³O₂/m²·day·atmosphere. Suitable materials include ethylene/vinyl alcohol copolymer (EVOH), polyvinylidene dichloride, vinylidene chloride/methyl acrylate copolymer, polyamide, polyester; and metallized PET. Alternatively, metal foil or SiOx compounds can be used to provide low oxygen transmission to the article. The exact oxygen permeability optimally required for a given application can readily be determined through experimentation by one skilled in the art. In medical applications, high barrier is often required to protect the quality of the product being packaged over the intended lifetime of the product. Higher oxygen permeability can readily be accomplished by blending the barrier polymer with any polymer that has a substantially higher oxygen permeability. Useful polymers for blending with barrier polymers include but are not limited to polymers and copolymers of alkyl acrylates, especially ethylene/butyl acrylate, ethylene/vinyl acetate copolymers, and the like.

The Radiation-curable Varnish

Electron-beam (e-beam) will penetrate all polymers to a given depth that depends only on the density of the material, the atomic number of the material, and the energy of the beam. Beam energy is determined by the acceleration voltage of the e-beam apparatus and is frequently measured in kiloelectron volts. The energy of the e-beam can be attenuated in a simple fashion by increasing distance from the unit. The energy of an e-beam is attenuated increasingly by materials that have greater atomic numbers. Materials containing elements with atomic numbers greater than that of carbon and hydrogen, such as nitrogen (having an atomic number of 7) and oxygen (having an atomic number of 8), will for a given thickness attenuate an e-beam more than a hydrocarbon polymer which by definition contains only carbon and hydrogen atoms. Such e-beam attenuating materials can be in the form of a polymer, ionomer, metal salt, or metal oxide. In a practical sense, such materials could be typical fillers such as titanium dioxide, calcium carbonate, alumina, silica, barium sulfate and the like that are typically optically opaque. When transparency is desired, metals can be introduced for example in the form of ionomers or other organic salts. For example, zinc, sodium, potassium, cesium, calcium, magnesium and aluminum ionomers are useful with this invention as e-beam attenuating materials or layers.

E-beams used for conventional crosslinking (film irradiation) processes are typically operated at accelerating voltages of 200,000 to 1 million volts or more depending upon the desired penetration depth. Only recently have e-beams been made that can reliably operate at voltages of less than 100,000 volts, or 100 kilovolts (100 kV). In particular, ultra-low voltage e-beam units that operate in the range of 50 kV are now available. At a beam energy of 50 keV, the estimated penetration depth is about 30 micrometers (30 μm) or 1.2 mil. Therefore, a film with greater than about 1 mil of polymer between the surface having an e-beam cured coating and the oxygen scavenging layer (OSL) will not be triggered by such a treatment (the thickness of the e-beam cured coating or other radiation-curable varnish is assumed herein to be negligible). The same film can be designed with less than about 1 mil of polymer between the opposite face and the OSL and can be effectively triggered by similar irradiation from the opposing side.

These processes are broadly applicable to all radiation-initiated oxygen scavenging systems.

When utilizing e-beam cured coatings, careful attention needs to be paid to the energy of the e-beam, and the film structure. Although accurate dose-depth curves are not currently available for ultra-low voltage e-beam units, the penetration depth can be estimated.

For an e-beam having an energy of 50 keV, the estimated penetration depth is about 1.2 mils (30 μm) thick. An oxygen scavenging film having about 2.5 mil thickness of polymer between the outer surface of the film (i.e. the outer surface of the film that will be furthest from the packaged article when the film is formed or otherwise made into a container for an article), and the layer comprising the oxygen scavenger (OSL) was not triggered by a 50 kGy dose from that unit. However, the same 50 kGy dose applied to the inner surface of the film (i.e. the outer surface of the film that will be closest to the packaged article when the film is formed or otherwise made into a container for an article), which has only about 0.3 mil thickness of polymer between the inner surface and the OSL, resulted in effective triggering of the oxygen scavenging reaction.

The superior physical properties (abuse, gloss, etc.) of energy cured inks and coatings can be used in conjunction with an oxygen scavenging film that is also triggered by such actinic radiation. By utilizing this invention, the triggering of the oxygen scavenging layer by actinic radiation can occur at a later point in time than the radiation curing of a coating or ink.

To improve the adhesion of the ink to the surface of the substrate film, the surface of the substrate film may be treated or modified before printing. Surface treatments and modifications include: i) physical treatments, such as corona treatment, plasma treatment, and flame treatment, and ii) primer treatment. Surface treatments and modifications are known to those of skill in the art. The flame treatment is less desirable for a heat-shrinkable film, since heat may prematurely shrink the film. The primer may be based on any of the ink resins previously discussed, preferably a cellulose, polyamide or ethylene vinyl acetate polymer (EVA) resin. The ink on the printed film should withstand without diminished performance the temperature ranges to which it will be exposed during packaging and use. For example, the ink on the printed film preferably withstands physical and thermal abuse (e.g., heat sealing) during packaging end-use, such as at temperatures of (in ascending order of preference) 100° C., 125° C., 150° C., and 175° C. for 3 seconds, more preferably 5 seconds, and most preferably 8 seconds.

An overprint varnish (i.e., overcoat) may be applied to the printed side of the printed substrate film to cover at least the printed image of the printed substrate film. Preferably, the overprint varnish covers a substantial portion of the printed image—that is, covering a sufficient portion of the printed image to provide the desired performance enhancements. Preferably, the overprint varnish is transparent.

The overprint varnish is preferably formed or derived from a radiation-curable overprint varnish system. Such a system has the ability to change from a fluid phase to a highly cross-linked or polymerized solid phase by means of a chemical reaction initiated by an actinic radiation energy source, such as ultra-violet (“UV”) light or electron beam (“EB”) radiation. Thus, the reactants of the radiation-curable overprint varnish system are “cured” by forming new chemical bonds under the influence of radiation. Radiation-curable inks and varnish systems are well known in the art, and are described e.g. in The Printing Ink Manual, Chapter 11, pp.636-77 (₅th ed., Kluwer Academic Publishers, 1993), pages 636-77. Suitable radiation curable coatings for use with this invention are disclosed in U.S. patent application Ser. No. 062,185 (Rooney et al.) filed Oct. 16, 1997 and incorporated herein by reference in its entirety. Suitable radiation curable coatings for use with this invention are disclosed in WO 99/19369 and EP 1023360 A2, both incorporated herein by reference in their entirety.

Radiation-curable overprint varnish systems or formulations can include: i) monomers (e.g., low-viscosity monomers or reactive “diluents”), ii) oligomers/prepolymers (e.g., acrylates), and optionally iii) other additives, such as non-reactive plasticizing diluents. Radiation-curable overprint varnish systems that are cured by UV light also include one or more photoinitiators. Radiation-curable overprint varnish systems curable by EB radiation do not require a photoinitiator, and may therefore be free of photoinitiator. Together, the monomers and oligomers/prepolymers may be grouped as “reactants.”

One or more of each of the reactive diluents/monomers and oligomers/prepolymers in a pre-cured overprint varnish formulation may have (in ascending order of preference) at least one, at least two, from two to ten, from two to five, and from two to three units of unsaturation per molecule. As is known in the art, one unit of unsaturation per molecule is known as monofunctional; two units of unsaturation per molecule is known as difunctional; and so on. Two or more terminal polymerizable ethylenically unsaturated groups per molecule are preferred.

Exemplary reactive diluents include (meth)acrylate diluents, such as trimethylolpropane triacrylate, hexanediol diacrylate, 1,3-butylene glycol diacrylate, diethylene glycol diacrylate, 1,6-hexanediol diacrylate, neopentyl glycol diacrylate, polyethylene glycol 200 diacrylate, tetraethylene glycol diacrylate, triethylene glycol diacrylate, pentaerythritol tetraacrylate, tripropylene glycol diacrylate, ethoxylated bisphenol-A diacrylate, propylene glycol mono/dimethacrylate, trimethylolpropane diacrylate, ditrimethylolpropane tetraacrylate, triacrylate of tris(hydroxyethyl) isocyanurate, dipentaerythritol hydroxypentaacrylate, pentaerythritol triacrylate, ethoxylated trimethylolpropane triacrylate, triethylene glycol dimethacrylate, ethylene glycol dimethacrylate, tetraethylene glycol dimethacrylate, polyethylene glycol-200 dimethacrylate, 1,6-hexanediol dimethacrylate, neopentyl glycol dimethacrylate, polyethylene glycol-600 dimethacrylate, 1,3-butylene glycol dimethacrylate, ethoxylated bisphenol-A dimethacrylate, trimethylolpropane trimethacrylate, diethylene glycol dimethacrylate, 1,4-butanediol diacrylate, diethylene glycol dimethacrylate, pentaerythritol tetramethacrylate, glycerin dimethacrylate, trimethylolpropane dimethacrylate, pentaerythritol trimethacrylate, pentaerythritol dimethacrylate, pentaerythritol diacrylate, aminoplast (meth)acrylates; acrylated oils such as linseed, soya, and castor oils. Other useful polymerizable compounds include (meth)acrylamides, maleimides, vinyl acetate, vinyl caprolactam, polythiols, vinyl ethers, and the like.

Useful oligomers/prepolymers include resins having acrylate functionality, such as epoxy acrylates, polyurethane acrylates, and polyester acrylates, with epoxy acrylates preferred. Exemplary oligomers and prepolymers include (meth)acrylated epoxies, (meth)acrylated polyesters, (meth)acrylated urethanes/polyurethanes, (meth)acrylated polyethers, (meth)acrylated polybutadiene, aromatic acid (meth)acrylates, (meth)acrylated acrylic oligomers, and the like.

If the radiation-curable overprint varnish is formulated for curing by exposure to UV-light, then the overprint varnish includes one or more photoinitiators. Useful photoinitiators include the benzoin alkyl ethers, such as benzoin methyl ether, benzoin ethyl ether, benzoin isopropyl ether and benzoin isobutyl ether. Another useful class of photoinitiators include the dialkoxyacetophenones, exemplified by 2,2-dimethoxy-2-phenylacetophenone (i.e., lrgacure®651 by Ciba-Geigy) and 2,2-diethoxy-2-phenylacetophenone. Still another class of useful photoinitiators include the aldehyde and ketone carbonyl compounds having at least one aromatic nucleus attached directly to the carboxyl group. These photoinitiators include, but are not limited to benzophenone, acetophenone, o-methoxybenzophenone, acetonaphthalenequinone, methyl ethyl ketone, valerophenone, hexanophenone, alpha-phenylbutyrophenone, p-morpholinopropiophenone, dibenzosuberone, 4-morpholinobenzophenone, 4′-morpholinodeoxybenzoin, p-diacetylbenzene, 4-aminobenzophenone, 4′-methoxyacetophenone, benzaldehyde, alpha-tetralone, 9-acetylphenanthrene, 2-acetylphenanthrene, 10-thioxanthenone, 3-acetylphenanthrene, 3-acetylindone, 9-fluorenone, 1-indanone, 1,3,5-triacetylbenzene, thioxanthen-9-one, isopropylthioxanthone, xanthene-9-one, 7-H-benz[de]-anthracen-7-one, 1-naphthaldehyde, 4,4′-bis(dimethylamino)-benzophenone, fluorene-9-one, 1′-acetonaphthone, 2′-acetonaphthone, 2,3-butanedione, acetonaphthene, and benz[a]anthracene 7.12 diene. Phosphines such as triphenylphosphine, bis acylphosphine oxides and tri-o-tolylphosphine are also useful as photoinitiators.

Preferred photoinitiators have low volatility, do not noticeably discolor the cured varnish, and do not produce undesirable by-products in the cured varnish that could migrate through the substrate. Specific examples include Irgacure® 2959 and Irgacure® 819, both from Ciba Speciality Chemicals, and Esacure® KIP 150, supplied by Sartomer Company. It is also well known to those skilled in the art that the use of synergists/co-initiators may improve photocure and may optionally be used. The preferred synergists/co-initiators would not noticeably discolor the cured varnish, or produce undesirable by-products in the cured varnish that could migrate through the substrate. Specific examples include Ebecryl® P104, Ebecryl® P115 and Ebecryl® 7100, all supplied by UCB chemicals Corp.

The radiation-curable overprint varnish formulation may optionally include small amounts (e.g., from 0.05 to 15 weight %) of polymerization inhibitors, processing aids, slip aids, flowout aids, antiblock agents, plasticizers, adhesion promoters, and other additives or components, such as those FDA-approved for food contact (direct or indirect), for example, as recited in the U.S. Code of Federal Regulations, 21 C.F.R. Section 175.300, which is incorporated herein in its entirety by reference. Such additives themselves preferably are reactive in that they polymerize and/or crosslink upon exposure to ionizing radiation, so as to become incorporated into the polymer matrix of the overcoat—or are of a high enough molecular weight so that the chance of migration into or toward the substrate film is reduced or eliminated. Preferred materials include those that contain (meth)acrylate functionalities. However, the radiation-curable overprint varnish may optionally include from 0.05 to 50 weight % non-reactant polymer soluble in the radiation-curable overprint varnish.

Preferably, the radiation-curable overprint varnish system is one that relies upon a free-radical mechanism to initiate and propagate the cure reaction (i.e., a free-radical radiation-curable overprint varnish). However, there are available radiation-curable cationic overprint systems, which use UV-light to initiate the reaction; but do not rely upon a free-radical mechanism. Accordingly, the reaction may continue even if no additional UV-light is provided. However, radiation-curable cationic overprint systems may suffer cure inhibition from the moisture in air, the components of inks (e.g. pigments, fillers, some resins, printing additives), and additives in the substrate film that are alkaline in nature. The sensitivity to alkaline materials is such that even trace amounts of contaminants that are typically found in a production setting may inhibit and/or prevent the cure. Further, cationic cure systems are not typically curable using EB radiation within useful dose ranges unless there is a initiator present such as that used in photocuring. Accordingly, the radiation-curable overprint varnish preferably excludes a radiation-curable cationic overprint varnish.

Useful radiation-curable overprint varnish systems are commercially available. For example, an EB curable overprint varnish is available from Rohm & Haas (previously Morton International, Inc.'s Adhesives & Chemical Specialties) under the MOR-QUIK 477 trademark. It has a density of about 9.05 lb./gal at 25° C., a refractive index of 1.484, an acid number of 0.5 mg KOH/g, and a viscosity at 25° C. of 100 cps. It contains multifunctional acrylic monomer and acrylated epoxy oligomer. It is believed to be substantially free of monofunctional monomer. Less preferred form Rohm & Haas is MOR-QUIK™ 444HP, which is believed to include substantially more acrylic monomer than (i.e., about twice as much as) the MOR-QUIK 477 overprint varnish.

A useful EB curable overprint varnish is also available from Sun Chemical under the product code GAIFBO440206™; it is believed to be essentially free of monomer/reactive diluent and contains a small amount (less than 15 weight %) water as diluent. It has a viscosity of about 200 cP at 25° C., a density of 8.9 lbs/gal, and boiling point of 212° F.

Other radiation-curable overprint varnishes include that from Rohm & Haas under MOR-QUIK™ 333; from Pierce and Stevens under the L9019™, L9024™, and L9029™ product codes; from Cork Industries, Inc. under CORKURE™ 119 HG, CORKURE™ 2053HG, CORKURE™ 601HG; from Environmental Inks and Coatings under the UF-170066™ product code; and from Rad-Cure Corporation under the RAD-KOTE™ 115, RAD-KOTE™ K261, RAD-KOTE™ 112S, RAD-KOTE™ 708HS, and RAD-KOTE™ 709 trademarks.

Useful concentrations of the reactants for a radiation-curable overprint varnish system vary from about 0 to about 95 weight % monomer and from about 95 to about 5 weight % oligomer/prepolymer. When copolymerizable components are included in the compositions, the amounts used depend on the total amount of ethylenically unsaturated component present; for example, in the case of polythiols, from 1 to 98% of the stoichiometric amount (based on the ethylenically unsaturated component) may be used.

More particularly, the radiation-curable overprint varnish system may include reactive monomer in an amount ranging from (in ascending order of preference) about 0 to about 60%, about 10 to about 50%, about 15 to about 40%, and about 15 to about 30%, based on the weight of the overprint varnish formulation. The oligomer/prepolymer may be present in amounts ranging from (in ascending order of preference) about 5 to about 90%, about 10 to about 75%, about 15 to about 50%, and about 15 to about 30%, also based on the weight of the overprint varnish formulation.

Useful overprint varnish formulations include (in ascending order of preference) less than 20%, less than 10%, less than 5%, less than 1%, and essentially free of monofunctional monomer, based on the weight of overprint varnish formulation. Useful over-print varnish formulations may also include (in ascending order of preference) less than 20%, less than 10%, less than 5%, less than 1%, and essentially free of monofunctional oligomer, based on the weight of overprint varnish formulation.

A UV-curable overprint varnish formulation may be similar to an electron beam formulation, except including photoinitiator. The preferred amount of photoinitiator present in a UV-curable system is the minimal amount sufficient to facilitate the polymerization reaction, since residual photoinitiator may remain in the overprint varnish to potentially migrate through the substrate film. Useful concentrations of photoinitiator include from about 0.5 to about 5%, more preferably from about 1 to about 3%, based on the weight of the overprint varnish system.

Viscosity

The desired viscosity for the overprint varnish depends in part on the coating application method to be used. The overprint varnish preferably has a viscosity such that it may be printed or applied in a similar manner as solvent-based inks. Typical viscosity application ranges include from about 20 to about 4,000, from about 50 to about 1,000, from about 75 to about 500, and from about 100 to about 300 centipoise (cP) measured at 25° C. The overprint varnish may be applied to the printed film using the same techniques as described previously with respect to the application of ink to form the printed image. Exemplary techniques include screen, gravure, flexographic, roll, and metering rod coating processes. Although application of the overcoat may occur cur separate in time and/or location from application of the printed image, it preferably occurs in-line with application of the ink that forms the printed image. For example, the overprint varnish may be applied to the printed image using the last stage of a multi-stage flexographic printing system.

Similarly, radiation curable inks may be formulated from the same type of components as over print varnishes, but of course include various pigments and/or dyes for color. In one embodiment of the invention, UV or EB cured inks are used with or without a subsequent OPV and comprise substantially the printed image. When printing with UV or EB cured inks, the inks are often cured partially or wholly after the application of each individual color forming the image. This is referred to as interstation irradiation, and may be followed by further radiation at the end of the process to complete the cure. Printing processes may be hybrid in nature, combining both UV and EB as disclosed in U.S. Pat. No. 5,407,708, which is included herein by reference as if set forth in full.

After application of the overprint varnish or energy curable inks to the printed film, the film is exposed to radiation to complete the coated, printed film. This polymerizes and/or crosslinks the reactants in the overcoat or ink, thus providing a hardened material. An electron beam is the preferred form of radiation, although UV-light radiation may be used if the coatings are formulated with photoinitiators. The radiation source for an EB system is known as an EB generator.

Two factors are important in considering the application of EB radiation: the dose delivered and the beam penetration. The dose is measured in terms of quantity of energy absorbed per unit mass of irradiated material; units of measure in general use are the megarad (Mrad) and kiloGray (kGy). The depth of penetration by an electron beam is directly proportional to the energy of the accelerated electrons impinging on the exposed material (energy of the electrons is expressed as kiloelectron volts, keV).

Regardless of the radiation source, the radiation dose is preferably sufficient to polymerize the reactants such that at least about 80%, 90%, 92%, 94%, 96%, 98%, 99%, and 100% of the reactive sites on the reactants polymerize and/or cross-link.

Useful radiation dosages range from about 0.05 to about 10 Mrads (1-100 kGy) Useful energies for the EB range from about 30 to about 250 keV.

It is believed that lower energies increase the cross-linking within the overprint varnish, because a greater proportion of the energy is deposited within the coating. Further, the use of EB radiation with an energy of less than about 70 keV penetrates the coated, printed film less deeply than higher-voltage EB—and is therefore less likely to degrade or alter the substrate film. Useful EB generation units include those commercially available from American International Technologies sold under the trademark MINI-EB (these units have operating voltages from about 30 to 70 kV) and from Energy Sciences, Inc. sold under the trademark EZ CURE (these units have operating voltages from about 70 to about 110 kV). EB generation units typically require adequate shielding, vacuum, and inert atmosphere blanketing, as is known in the art. If the processing techniques employed allow for the use of a low oxygen environment, the coating and irradiation steps preferably occur in such an atmosphere. A standard nitrogen flush can be used to achieve such an atmosphere. The oxygen content of the coating environment preferably is no greater than about 300 ppm for an E-beam unit, but can range up to atmospheric (nominally 21%) for UV.

Useful radiation-cured overprint varnish thicknesses include from about 0.1 to about 12 μm, from about 0.5 to about 10 μm, from about 1.0 to about 8 μm, from about 1.5 to about 5 μm, and from about 1.5 to about 2.5 μm.

If the article is a coated, printed thermoplastic film, it preferably has low haze characteristics. Haze is a measurement of the transmitted light scattered more than 2.5° from the axis of the incident light. Haze is measured against the outer (i.e., overprint coated side) of the coated, printed film, according to the method of ASTM D 1003, which is incorporated herein in its entirety by reference. All references to “haze” values in this application are by this standard. Preferably, the haze is no more than about 20%, 15%, 10%, 9%, 8%, 7%, and 6%.

If the article is a coated, printed film, it preferably has a gloss, as measured against the outer (overprint varnish side) of at least about 40%, 50%, 60%, 63%, 65%, 70%, 75%, 80%, 85%, 90%, and 95%. All references to “gloss” values in this application are in accordance with ASTM D 2457 (60° angle), which is incorporated herein in its entirety by reference. Preferably, the coated, printed film is transparent (at least in the non-printed regions) so that a packaged food item is visible through the film. “Transparent” as used herein means that the material transmits incident light with negligible scattering and little absorption, enabling objects (e.g., packaged food or print) to be seen clearly through the material under typical viewing conditions (i.e., the expected use conditions of the material).

The measurement of optical properties of plastic films, including the measurement of total transmission, haze, clarity, and gloss, is discussed in detail in Pike, LeRoy, “Optical Properties of Packaging Materials,” Journal of Plastic Film & Sheeting, vol. 9, no. 3, pp. 173-80 (July 1993), of which pages 173-80 is incorporated herein by reference.

The film may be printed by any suitable method, such as rotary screen, gravure, or flexographic techniques, as is known in the art. The printed image may also be formed in part or in whole by digital imaging techniques such as ink jet, electrophotographic or xerographic techniques. The printed image is applied to the film by printing the ink on the film, preferably the outer non-food side of the film. If a solvent-based ink (i.e., a non-chemically reactive ink) is applied to the film, the solvent evaporates, leaving behind the resin-pigment combination. The solvent may evaporate as a result of heat or forced air exposure to speed drying. The ink may be applied in layers, each with a different color, to provide the desired effect. For example, a printing system may employ eight print stations, each station with a different color ink.

An overprint varnish may be applied by any of the techniques known in the art, including screen, gravure, flexographic, roll, and metering rod coating print techniques, and by in-line, stack, and central impression configurations. Although application of the overcoat may occur separately in time and/or location from application of the printed image, it preferably occurs in-line with application of the ink that forms the printed image. For example, the overprint varnish may be applied to the printed image using the last stage of a multi-stage flexographic printing system.

The invention can be used in connection with various articles of manufacture, compounds, compositions of matter, coatings, etc. Two preferred forms are rigid containers and flexible films, both useful in packaging of food and non-food products. Examples of semi-rigid and rigid containers include trays, stand-up pouches, bottles, and cups. In addition to semi-rigid packaging, rigid containers, and traditional flexible film applications, the invention can be used in association with, foamed articles, paperboard liners, and in other systems where an oxygen scavenger has been incorporated

The invention can be used in the packaging of a wide variety of oxygen sensitive products including fresh red meat such as beef, pork, lamb, and veal, smoked and processed meats such as sliced turkey, pepperoni, ham and bologna, vegetable products such as tomato based products, other food products, including pasta and baby food, beverages such as beer and wine, salted snacks, coffee, spices, and products such as electronic components, pharmaceuticals, medical products, and the like. The invention is readily adaptable to various vertical form-fill-and-seal (VFFS) and horizontal form-fill-and-seal (HFFS) packaging lines.

### EXAMPLES

A low voltage e-beam unit was operated with a beam energy of about 50 keV. At this voltage, the maximum penetration depth was about 30 μm. Given the structure of a commercial oxygen scavenging film available from Cryovac, Inc. shown below, it was possible to irradiate the outer surface of the film with little or no effect on the oxygen scavenging layer (OSL), while irradiation of the inner surface triggered the scavenging reaction.

Results And Discussion

Tests were run to compare the effectiveness of triggering oxygen scavenging film with ultra-low voltage e-beam and UV-C light.

The generalized structure of an oxygen scavenging film is shown below in Table 1.

TABLE 1
General Structure

| Outer | | | | | | |
|---|---|---|---|---|---|---|
| Surface | PET | Adhesive | EVA | OSL | sealant | Inner Surface |
| Gauge | 0.5 | — | 2.0 | 0.5 | 0.3 | Mil |

The oxygen scavenging structure shown above, having a total film thickness of about 3.3 mils, was dosed with low voltage e-beam to the outer surface at a high enough level to cure a coating or ink system without triggering the scavenging reaction in the OSL. On the other hand, irradiation from the inner surface of the film structure deposited substantial energy within the OSL, enough to trigger the oxygen scavenger in the OSL. Portions of film were irradiated as described above to a dose of 50-55 kGy. The results are shown below in Table 2.

TABLE 2
Low Voltage E-beam Treatment of Oxygen Scavenging Film
(Refrigerated Modified Atmosphere Packaging Conditions)

| | | Average | | Ins. Rate | | Capacity^{c} | |
|---|---|---|---|---|---|---|---|
| | Induction | Rate^{b} (cc | | (cc | | (cc | |
| | Period | O₂/m²/day) | | O₂/m²/day) | | O₂/m²/mil) | |
| Sample Details | (days) | Mean | σ | Mean | σ | Mean | σ |
| UVC control^{a} | > 1 < 2 | 23.1 | 2.0 | 39 (5) | 3 | 1031 | 17 |
| PET side up | >32 | 0 | — | 0 | — | 0 | — |
| Sealant side up | ≦1 | 26.4 | 9 | 35 (2) | 4 | 958 | 156 |

^{a}Anderson/Vreeland unit, UVC dose = 800 mJ/cm².
^{b}Average rate is calculated at 5 days.
^{c}Capacity is after 32 days.

It can be seen from the data in Table 2 that e-beam treatment from the sealant side was effective in triggering oxygen scavenging while treatment from the PET side did not trigger the oxygen scavenger after 32 days when the test was arbitrarily stopped. The “Ins. Rate” in the table is the peak instantaneous scavenging rate and the number in parenthesis is the days after triggering required to reach that rate.

To determine if e-beam treatment of the PET side of the film would significantly reduce the shelf life of the film, additional samples were irradiated and placed in air at room temperature. The results of these tests are shown below in Table 3.

TABLE 3
Treatment of Oxygen Scavenging film with E-beam
Room Temperature, Air Conditions

| | | Average | | Ins. Rate | | Capacity^{b} | |
|---|---|---|---|---|---|---|---|
| | Induction | Rate^{a} (cc | | (cc | | (cc | |
| | Period | O₂/m²/day) | | O₂/m²/day) | | O₂/m²/mil) | |
| Sample Details | (days) | Mean | σ | Mean | σ | Mean | σ |
| PET side up | >32 | 0 | — | 0 | — | 0 | — |
| Sealant Side up | <1 | 173.1 | 11.8 | 336 (2) | 33 | 3945 | 206 |

^{a}Average rate is at 5 days.
^{b}Capacity is after 32 days.

The results in Table 3 show that after 32 days, the e-beamed sample had not yet scavenged when held in air at room temperature. A portion of film that was irradiated with the sealant side up was also held in air at room temperature. These results show how rapid oxygen scavenging can take place, and demonstrate the ultimate capacity of the film.

Thus, an oxygen scavenging layer can be used in a structure that has a UV or e-beam cured coating or ink system without prematurely triggering the scavenging reaction. Therefore, it is possible to incorporate an oxygen scavenger, specifically one triggered by actinic radiation such as UV or e-beam, into films that utilize energy curable coatings and/or inks.

The invention is not limited to the illustrations described herein, which are deemed to be merely illustrative, and susceptible of modification of form, size, arrangement of parts and details of operation.

What is claimed is:

1. A multilayer article comprising:
a) a first outer surface;
b) a second outer surface; and
c) a first layer comprising an oxygen scavenger;
wherein the first outer surface comprises
i) a printed image, and
ii) a radiation-curable varnish covering at least a portion of the printed image.

2. The multilayer article of claim 1 wherein the article is in the form of a film.

3. The multilayer article of claim 1 wherein the article is in the form of a film, wherein the film comprises:
a) a layer comprising an oxygen scavenger; and
b) a layer comprising a polymer having an oxygen transmission rate of less than 500 cm³/m²·day·atm (ASTM D 3985-95).

4. The multilayer article of claim 1 wherein the oxygen scavenger comprises a material selected from the group consisting of:
i) oxidizable organic compound and a transition metal catalyst,
ii) ethylenically unsaturated hydrocarbon and a transition metal catalyst,
iii) a reduced form of a quinone, a photoreducible dye, or a carbonyl compound which has absorbence in the UV spectrum,
iv) a polymer having a polymeric backbone, cyclic olefinic pendent group, and linking group linking the olefinic pendent group to the polymeric backbone,
v) a copolymer of ethylene and a strained, cyclic alkylene, and
vi) ethylene/vinyl aralkyl copolymer.

5. The multilayer article of claim 1 wherein the article comprises a UV absorber selected from the group consisting of:
i) polymeric UV absorber,
ii) substituted hydroxybenzophenone,
iii) substituted cinnamate,
iv) substituted benzotriazole, and
v) pigment.

6. The multilayer article of claim 1 wherein the article comprises an e-beam attenuating material containing an element with an atomic number of at least 7.

7. A method comprising:
a) providing a multilayer article comprising
i) a first outer surface;
ii) a second outer surface; and
iii) a first layer comprising an oxygen scavenger;
b) printing an image on the first outer surface; and
c) applying a radiation-curable varnish on the first outer surface so as to cover at least a portion of the printed image.

8. The method of claim 7 comprising providing a multilayer article in the form of a film.

9. The method of claim 7 comprising, after step c), exposing the first outer surface, with the printed image and radiation-curable varnish thereon, to actinic radiation at a dosage effective to cure the radiation-curable varnish, but not trigger the oxygen scavenger in the article.

10. A multilayer article comprising:
a) a first outer surface;
b) a second outer surface; and
c) a first layer comprising an oxygen scavenger;
wherein the first outer surface comprises a radiation-curable printed image.

11. The multilayer article of claim 10 wherein the article is in the form of a film.

11. The multilayer article of claim 10 wherein the article is in the form of a film, wherein the film comprises:
a) a layer comprising an oxygen scavenger; and
b) a layer comprising a polymer having an oxygen transmission rate of less than 500 cm³/m²·day·atm (ASTM D 3985-95).

12. The multilayer article of claim 10 wherein the oxygen scavenger comprises a material selected from the group consisting of:
i) oxidizable organic compound and a transition metal catalyst,
ii) ethylenically unsaturated hydrocarbon and a transition metal catalyst,
iii) a reduced form of a quinone, a photoreducible dye, or a carbonyl compound which has absorbence in the UV spectrum,
iv) a polymer having a polymeric backbone, cyclic olefinic pendent group, and linking group linking the olefinic pendent group to the polymeric backbone,
v) a copolymer of ethylene and a strained, cyclic alkylene, and
vi) ethylene/vinyl aralkyl copolymer.

13. The multilayer article of claim 10 wherein the article comprises a UV absorber selected from the group consisting of:
i) polymeric UV absorber,
ii) substituted hydroxybenzophenone,
iii) substituted cinnamate,
iv) substituted benzotriazole, and
v) pigment.

14. The multilayer article of claim 10 wherein the article comprises a varnish covering at least a portion of the radiation-curable printed image.

15. The multilayer article of claim 14 wherein the varnish comprises a radiation-curable varnish.

16. A method comprising:
a) providing a multilayer article comprising
i) a first outer surface;
ii) a second outer surface; and
iii) a first layer comprising an oxygen scavenger; and
b) printing a radiation-curable image on the first outer surface.

17. The method of claim 16 comprising providing a multilayer article in the form of a film.

18. The method of claim 16 comprising, after step b), exposing the first outer surface, with the printed radiation-curable image thereon, to actinic radiation at a dosage effective to cure the radiation-curable varnish, but not trigger the oxygen scavenger in the article.

19. The method of claim 16 comprising applying a varnish on the first outer surface so as to cover at least a portion of the radiation-curable printed image.

20. The method of claim 16 comprising applying a radiation-curable varnish on the first outer surface so as to cover at least a portion of the radiation-curable printed image.
